(19) United States
(12) Patent Application Publication
(10) Pub. No.: US 2011/0029212 A1
(43) Pub. Date: Feb. 3, 2011

(54) METHOD OF IDENTIFYING POSITIONS OF BRAKE MONITORS

(75) Inventors: Erik Carresjö, Kama (SE); Per Hasselberg, Torslanda (SE)

Correspondence Address: WRB-IP LLP, 801 N. Pitt Street, Suite 123, ALEXANDRIA, VA, 22314, US

(73) Assignee: Volvo Lastvagnar AB, Goteborg (SE)

(21) Appl. No.: 12/934,671

(22) PCT Filed: Apr. 10, 2008
(86) PCT No.: PCT/SE2008/000261

§ 371 Date: Sep. 27, 2010

(51) Int. Cl. G06F 19/00

(52) U.S. Cl. 701/70

(57) ABSTRACT

A method of identifying positions of brake monitors in relation to wheel brake units of a vehicle is provided. The brake monitors communicate by wireless to a control apparatus of the vehicle. The method includes steps of: (a) installing the brake monitors in association with the brake units; (b) individually or group-wise actuating the brake units in a sequence whilst monitoring corresponding brake unit actuations by using the brake monitors and generating corresponding brake unit actuation signals; (c) communicating the brake unit actuation signals from the brake monitors to the control apparatus; and (d) receiving the brake unit actuation signals at the control apparatus, and identifying from the received brake unit actuation signals positions whereat the brake monitors are installed on the vehicle. The method permits sequential actuation of the brake units and corresponding monitoring of associated signals generated by their brake monitors is capable of enabling installation positions of the brake monitors of being identified automatically.

### FIELD OF THE INVENTION

The present invention relates to methods of identifying positions of brake monitors in relation to wheel brake units of vehicles. Moreover, the present invention also concerns brake monitoring systems operable to execute aforesaid methods. Furthermore, the present invention relates to software products, recording on data carriers, wherein the software products are executable on computing hardware to implement aforesaid methods.

### BACKGROUND OF THE INVENTION

Vehicle brakes are safety-critical components of vehicles, such that dangerous situations are susceptible to arising when vehicle brakes fail in operation. In consequence, it is known from a published international PCT patent application no. PCT/SE2006/000470 (WO 2006/112784 A1) to include monitoring devices within brake pads; the devices are operable to sense states of wear of the brake pads, and to communicate by wireless signals indicative of the states of wear. The wireless signals are receivable at control apparatus operable to generate driver information indicative of brake pad wear. When the brake pad wear approaches an unacceptable degree, the brake pads are beneficially replaced with new corresponding brake pads so that vehicle brake operation is more reliably ensured.

However, inclusion of monitoring devices in brake pads as described in the foregoing suffers problems. A first problem is that brake pads are operable to dissipate in operation significant amounts of energy which results in the brake pads momentarily being heated to elevated temperatures of potentially several hundred degrees Centigrade. Such elevated temperatures are susceptible to exceeding a maximum operating temperature of semiconductor components, for example electronic integrated circuits and electro-chemical batteries, included in the monitoring devices. A second problem is that, after installation of brake pads including corresponding wireless monitoring devices onto wheel assemblies of a vehicle, the control apparatus requires programming regarding whereat the brake monitors are installed on the vehicle so that a wheel assembly corresponding to a worn brake pad can be subsequently identified for purposes of replacing the worn brake pad.

The first and second problems have prevented such brake pads including monitoring devices embedded therein from finding general widespread use, despite brake pad wear continuing to be a major safety issue, especially for heavy road vehicles intended to haul freight containers and similar.

Use of other types of wireless monitoring devices is known from published patent specifications. For example, in a published United States patent no. U.S. Pat. No. 5,302,939, there is described a dual tire equalizer having a remote indicator for a vehicle. The equalizer includes a diaphragm provided with an axial probe which is operable to selectively actuate a switch in a radio frequency transmitter circuit mounted on a wheel. The transmitter is operable to send a signal which varies in response to a condition of the switch. A radio frequency receiver on a vehicle and connected to an indicator in a driver's cab of the vehicle responds to the signal and issues appropriate information to the driver concerning condition of the equalizer.

### SUMMARY OF THE INVENTION

An object of the present invention is to provide a method of identifying positions of brake monitors for rendering use of such brake monitors easier.

According to a first aspect of the invention, there is provided a method of identifying positions of brake monitors in relation to wheel brake units of a vehicle as defined in appended claim 1: there is provided a method of identifying positions of brake monitors in relation to wheel brake units of a vehicle, the brake monitors being operable to communicate by wireless to at least one control apparatus of the vehicle,

characterized in that the method includes steps of:
(a) installing the brake monitors in association with the brake units;
(b) individually or group-wise actuating the brake units in a sequence whilst monitoring corresponding brake unit actuations by using the brake monitors and generating corresponding brake unit actuation signals;
(c) communicating the brake unit actuation signals from the brake monitors to the at least one control apparatus; and
(d) receiving the brake unit actuation signals at the at least one control apparatus, and identifying from the received brake unit actuation signals positions whereat the brake monitors are installed on the vehicle.

The invention is of advantage in that sequential actuation of the brake units and corresponding monitoring of associated signals generated by their brake monitors is capable of enabling installation positions of the brake monitors to be identified automatically.

Optionally, the method includes a step of providing each brake monitor with at least one identification code for use when communicating from the brake monitor to the at least one control apparatus, the at least one identification code enabling the brake monitor to be uniquely individually or group-wise identified by the at least one control apparatus when in communication therewith. Use of the identification code enables actuation signals subsequently generated by the brake monitor to be associated with a corresponding brake unit to which the brake monitor has been installed. Optionally, the brake monitors are uniquely identified in groups of brake monitors, for example pairs of brake monitors.

Optionally, the method is implemented such that each brake monitor is operable to monitor movement of at least one brake block of its corresponding brake unit during actuation of the brake unit. The brake monitor is thereby potentially capable of not only sensing correct actuation but also a degree of wear which the brake block has undergone in operation.

Optionally, the method is implemented such that the brake monitors are operable to function in a first hibernating state to conserve power, and a second active state for communicating an indication of actuation of their associated brake units, wherein switching between the first hibernating state and the second active state occurs for each brake monitor in association with actuation of its corresponding braking unit. Such operation of the brake monitors is of benefit when the brake monitors are powered from electrochemical batteries local thereto and also need to function from electrical energy supplied from the batteries for a period of many months or even several years.

Optionally, the method is implemented such that the brake monitors are coupled to actuators of their corresponding brake units which are operable to apply associated brake blocks, the brake monitors being mounted at locations spaced apart from the brake blocks for reducing exposure of the brake monitors to heat generated in the brake blocks when in operation. Such mounting of the brake monitors assists to reduce exposure of the brake monitors to heat generated by the brake units when in operation to absorb kinetic energy of the vehicle.

According to a second aspect of the invention, there is provided a brake monitoring system as claimed in appended claim 6: there is provided a brake monitoring system for a vehicle, the system comprising at least one control apparatus and brake units which are susceptible to being individually or group-wise actuated in sequence, the system further comprising brake monitors coupled to the brake units for monitoring operation of the brake units, the brake units being coupled in communication with the at least one control apparatus of the system, wherein the system is operable to implement a method pursuant to the first aspect of the invention.

According to a third aspect of the invention, there is provided a software product stored on a data carrier as claimed in appended claim 7: there is provided a software product stored on a data carrier, the software product being executable on computing hardware for performing a method pursuant to the first aspect of the invention.

It will be appreciated that features of the invention are susceptible to being combined in any combination without departing from the scope of the invention as defined by the appended claims.

### DESCRIPTION OF THE DIAGRAMS

Embodiments of the invention will now be described, by way of example only, with reference to the following diagrams wherein:

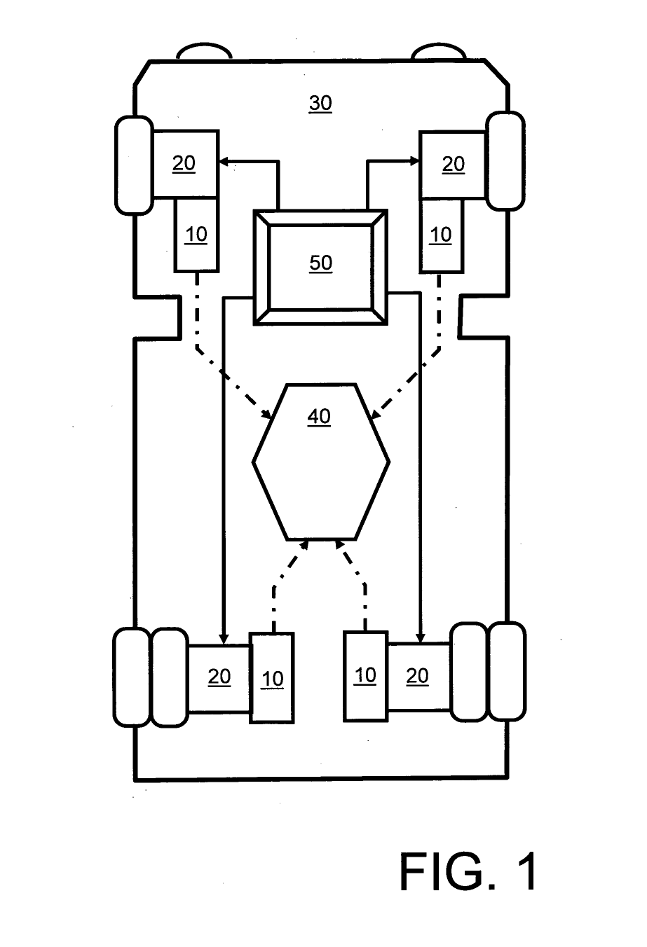

FIG. 1 is a schematic plan view of a vehicle including a plurality of brake units associated with wheels of the vehicle, the brake units being equipped with corresponding brake monitors operable to sense operation of their brake units, and at least one control apparatus operable to communicate with the brake monitors and thereby receive information indicative of actuation of the brake units;

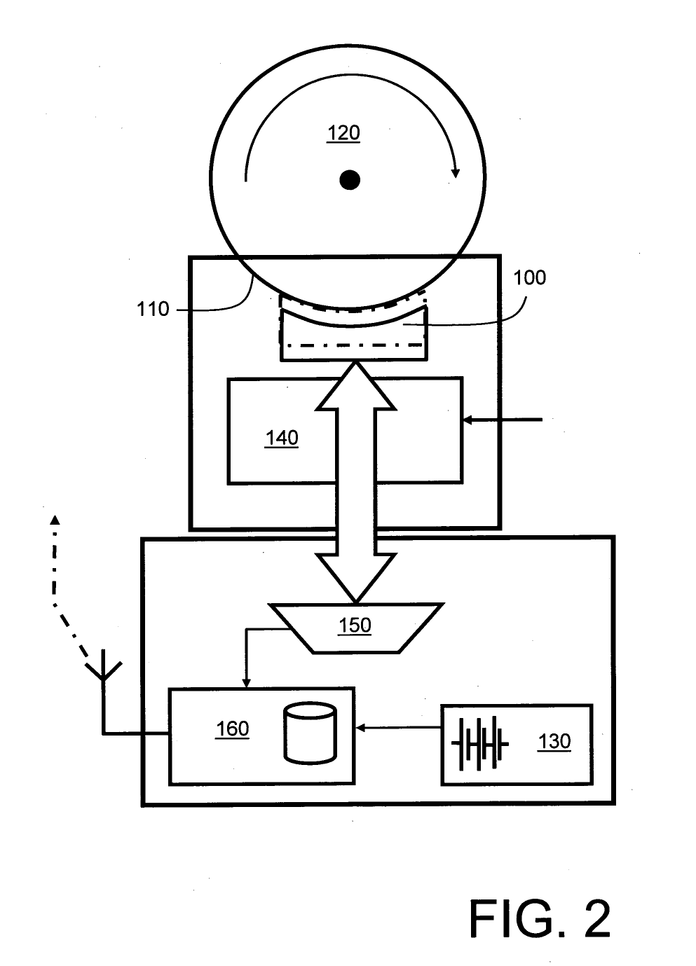

FIG. 2 is a schematic diagram of a brake monitor and its associated brake unit for use with the vehicle of FIG. 1; and

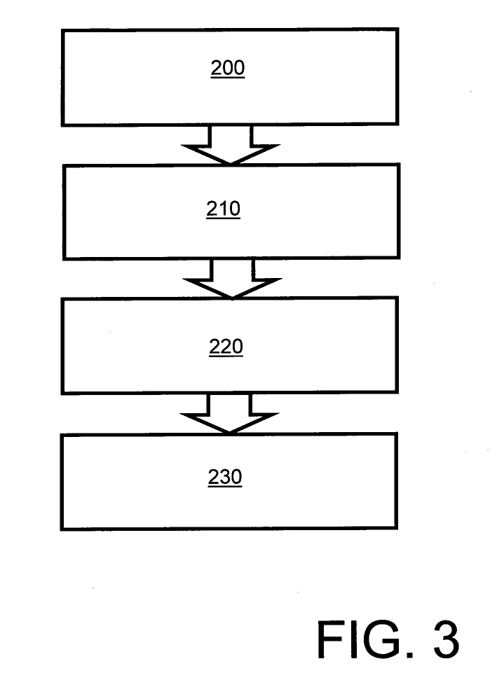

FIG. 3 is a flow chart including steps of a method of identifying positions of brake monitors in the vehicle of FIG. 1.

### DESCRIPTION OF EMBODIMENTS OF THE INVENTION

In overview, with reference to FIG. 1, the present invention is concerned with a method of identifying positions of brake monitors 10 in relation to wheel brake units 20 of a vehicle 30. The brake monitors 10 are operable to communicate by wireless to at least one control apparatus 40 of the vehicle 30. Moreover, the method includes a first step of installing the brake monitors 10 in association with the brake units 20. Additionally, the method includes a second step of individually or group-wise actuating the brake units 20 in a sequence whilst monitoring corresponding brake unit 20 actuations by using the brake monitors 10 and generating corresponding brake unit actuation signals. Furthermore, the method includes a third step of communicating the brake unit actuation signals from the brake monitors 10 to the at least one control apparatus 40. Lastly, the method includes a fourth step of receiving the brake unit actuation signals at the at least one control apparatus 40, and identifying from the received brake unit actuation signals positions whereat the brake monitors 10 are installed on the vehicle 30.

The at least one control apparatus 40 is optionally a part of a safety system of the vehicle 30. Alternatively, the at least one control apparatus 40 includes a data bus, for example implemented using a proprietary CAN bus as proposed by Philips NV in the Netherlands, through which diverse operating functions of the vehicle 30 are communicated in operation.

The present invention is, for example, relevant when the brake monitors 10 are being installed to the brake units 20. Each brake monitor 10 is provided or allocated a reference identification code ID which the brake monitor 10 is operable to communicate to the at least one apparatus 40 by which the at least one apparatus 40 is able to uniquely identify each of the brake monitors 10. Alternatively or additionally, the brake monitors 10 are susceptible to being identified in groups, for example in pairs, identification codes uniquely identifying such groups. Moreover, the brake units 20 are permanently coupled, namely hardwired, in communication with a braking system 50 of the vehicle 30 so that each brake unit 20, or a group of brake units 20 such as a pair of brake units 20, is capable of being specifically actuated. By sequentially actuating individual known brake units 20, or groups of known brake units 20, and recording which brake monitors 10 respond to such actuation together with corresponding reference codes ID's, the locations of the brake monitors 10 installed on the vehicle 30 can thereby be automatically determined.

Thus, when implementing the method, it is desirable that each brake monitor 10 is provided with at least one reference identification code ID for use when communicating from the brake monitor 10 to the at least one control apparatus 40, wherein the at least one identification code enables the brake monitor 10 to be uniquely identified by the at least one control apparatus 40 when in communication therewith.

Referring to FIG. 2, each brake monitor 10 is operable to monitor movement of at least one brake block 100 of its corresponding brake unit 20 during actuation of the brake unit 20. The brake block 100 is actuated in operation towards a braking surface 110 which revolves together with a corresponding wheel 120 of the vehicle 30. Each brake monitor 10 is optionally operable using a sensor 150 to sense a distance that its brake block 100 moves under actuation to provide a sensed indication of a degree of wear that the brake lock 100 has undergone. Such sensing using the sensor 150 is optionally achieved by using one or more of: a potentiometer, a magnetic proximity sensor, an electrostatic proximity sensor, an optical sensor, a capacitive sensor.

In order to reduce wiring complexity within the vehicle 30, thereby potentially reduce its manufacturing cost and simplify its maintenance, the brake monitors 10 are beneficially energized by a source of power which is local thereto, for example the source of power being implemented as a battery of electrochemical cells denoted by 130. However, it is not necessary for wheel monitoring purposes that the brake monitors 10 are continuously energized for sensing operation of their respective brake units 20. Optionally, therefore, when implementing the method, the brake monitors 10 are operable to function in a first hibernating state to conserve power, and a second active state for communicating an indication of actuation of their associated brake units 20, wherein switching between the first hibernating state and the second active state occurs for each brake monitor 10 in association with actuation of its corresponding braking unit 20.

As described in the foregoing, it is beneficial that the brake monitors 10 are at least partially isolated and protected from heat generated by operation of their corresponding brake units 20, for example from their one or more brake blocks 100. Thus, optionally, the brake monitors 10 are coupled to actuators 140 of their corresponding brake units 20 which are operable to apply associated one or more brake blocks 100, wherein the brake monitors 10 are mounted at locations spaced apart from the brake blocks 100 for reducing exposure of the brake monitors 10 to heat generated in the brake blocks 100 when in operation. When the brake monitors 10 are installed in groups, for example in pairs, and mounting positions of the groups of brake monitors 10 only need to identified pursuant to the present invention to a resolution of the groups, such that the brake monitors 10 are actuated in groups and their corresponding actuation sensing responses then recorded at the at least one apparatus 40 for identifying which groups of brake units 20 with which the group of brake monitors 10 are associated.

The at least one control apparatus 40 and the brake units 20 together with their brake monitors 10 are beneficially considered to comprise a brake monitoring system. The at least one control apparatus 40 and the brake units 20 of the system are susceptible to being individually or group-wise actuated in sequence, and the system beneficially further comprises the brake monitors 10 coupled to the brake units 20 for monitoring operation of the brake units 20; the brake units 20 are coupled in communication with the at least one control apparatus 40 of the system, and the system is operable to implement the aforementioned method.

The method is beneficially implemented using one or more software products executable on computing hardware included at one or more of the brake monitors 10 and the at least one control apparatus 40. The one or more software products are susceptible to being conveyed on a data carrier, for example via a signal, a solid state memory, an optical memory medium to mention a few implementations. For example, each brake monitor 10 is provided with an associated computing device 160 for directing sensing operations, sensed actuation signal conditioning and protocols for wireless communication with the at least one control apparatus 40.

Steps of the aforementioned method are shown in FIG. 3. The first step of installing the brake monitors 10 in association with the brake units 20 is denoted by 200. Additionally, the second step of individually or group-wise actuating the brake units 20 in a sequence whilst monitoring corresponding brake unit 20 actuations by using the brake monitors 20 and generating corresponding brake unit actuation signals is denoted by 210. Furthermore, the third step of communicating the brake unit actuation signals from the brake monitors 20 to the at least one control apparatus 40 is denoted by 220. Lastly, the fourth step of receiving the brake unit actuation signals at the at least one control apparatus 40, and identifying from the received brake unit actuation signals positions whereat the brake monitors 10 are installed on the vehicle 30 is denoted by 230.

Although wireless communication between the brake monitors 10 and the at least one control apparatus 40, for example via Bluetooth or similar wireless protocol, is employed, alternative communication routes are alternatively or additionally employed. Such alternative communication routes optionally include one or more of: optical communication, acoustic communication, hardwired connection.

The at least one control apparatus 40 is beneficially implemented as an arrangements of one or more monitoring apparatus, for example implemented as a brake integrity monitoring system or apparatus.

Expressions such as “has”, “is”, “include”, “comprise”, “consist of”, “incorporates” are to be construed to include additional components or items which are not specifically defined; namely, such terms are to be construed in a non-exclusive manner. Moreover, reference to the singular is also to be construed to also include the plural. Furthermore, numerals and other symbols included within parentheses in the accompanying claims are not to be construed to influence interpreted claim scope but merely assist in understanding the present invention when studying the claims.

Modifications to embodiments of the invention described in the foregoing are susceptible to being implemented without departing from the scope of the invention as defined by the appended claims.

1. A method of identifying positions of brake monitors in relation to wheel brake units of a vehicle, said brake monitors being operable to communicate by wireless to at least one control apparatus of the vehicle,
characterized in that said method includes steps of:
(a) installing said brake monitors in association with said brake units;
(b) individually or group-wise actuating said brake units in a sequence whilst monitoring corresponding brake unit actuations by using said brake monitors and generating corresponding brake unit actuation signals;
(c) communicating said brake unit actuation signals from said brake monitors to said at least one control apparatus; and
(d) receiving said brake unit actuation signals at said at least one control apparatus, and identifying from said received brake unit actuation signals positions whereat said brake monitors are installed on said vehicle.

2. A method as claimed in claim 1, wherein said method includes a step of providing each brake monitor with at least one identification code for use when communicating from said brake monitor to said at least one control apparatus, said at least one identification code enabling said brake monitor to be uniquely individually or group-wise identified by said at least one control apparatus when in communication therewith.

3. A method as claimed in claim 1 or 2, wherein each brake monitor is operable to monitor movement of at least one brake block of its corresponding brake unit during actuation of the brake unit.

4. A method as claimed in claim 1, 2 or 3, wherein said brake monitors are operable to function in a first hibernating state to conserve power, and a second active state for communicating an indication of actuation of their associated brake units, wherein switching between said first hibernating state and said second active state occurs for each brake monitor in association with actuation of its corresponding braking unit.

5. A method as claimed in any one of the preceding claims, wherein said brake monitors are coupled to actuators of their corresponding brake units which are operable to apply associated brake blocks, said brake monitors being mounted at locations spaced apart from said brake blocks for reducing exposure of said brake monitors to heat generated in said brake blocks when in operation.

6. A brake monitoring system for a vehicle, said system comprising at least one control apparatus and brake units which are susceptible to being individually or group-wise actuated in sequence, said system further comprising brake monitors coupled to said brake units for monitoring operation of said brake units, said brake units being coupled in communication with said at least one control apparatus of said system, wherein said system is operable to implement a method as claimed in any one of the preceding claims.

7. A software product stored on a data carrier, said software product being executable on computing hardware for performing a method as claimed in any one of claims 1 to 5.
